(19) United States
(12) Patent Application Publication
(10) Pub. No.: US 2025/0017123 A1
(43) Pub. Date: Jan. 16, 2025

(54) METHOD FOR CONTROLLING A THREE-POINT HITCH

(71) Applicant: DEERE & COMPANY, MOLINE, IL (US)

(72) Inventors: PATRICK BECHTOLD, LAMBSHEIM (DE); LUCAS SCHREIECK, HASSLOCH IN DER PFALZ (DE)

(21) Appl. No.: 18/675,263

(22) Filed: May 28, 2024

(30) Foreign Application Priority Data
Jul. 10, 2023 (DE) 102023118128.9

(51) Int. Cl. A01B 59/06; A01B 76/00

(52) U.S. Cl. CPC A01B 59/067; A01B 76/00

(57) ABSTRACT

A method for controlling a three-point hitch, having left and right lower linkages with each pivotably linked to a tractor-side support structure in a first end region and each having a coupling element for attaching accessory equipment in a second end region, includes pivoting the lower linkages via a lifting mechanism which lifts and lowers the coupling elements with respect to the ground, and activating the lifting mechanism in a cleaning mode via a control unit such that an acceleration pulse directed towards the ground is produced in the region of the coupling elements by interrupting a short-stroke lowering movement generated at the lower linkages.

### CROSS-REFERENCE TO RELATED APPLICATIONS

This application claims priority to German Patent Application No. 102023118128.9. filed Jul. 10, 2023, which is hereby incorporated by reference.

### FIELD OF THE DISCLOSURE

The disclosure relates to a method for controlling a three-point hitch.

### BACKGROUND

Three-point hitches of this type are widely used in agricultural tractors and serve for attaching, among other things, supported accessory equipment for soil tillage, for example a plow, a harrow, a cultivator or the like.

### SUMMARY

The three-point hitch, which is provided in the rear (or also the front) region of the agricultural tractor comprises left and right lower linkages, which are pivotably attached in the lower region of a supporting chassis structure of the agricultural tractor via associated link points. In the case of a rear three-point hitch, this is usually a differential housing. A central upper linkage, which is pivotably arranged at a further link point in an upper region of the supporting chassis structure of the agricultural tractor serves for the upper support or guidance of accessory equipment attached to the three-point hitch. The lower linkage and the upper linkage have, at their free ends, respective coupling elements in the form of self-locking arresting hooks in which the accessory equipment can be suspended by means of ball couplers of a complementary design.

To lift and lower the accessory equipment, a hydraulically controllable lifting mechanism is provided, which has left and right lifting arms which can be pivoted about a common shaft by means of at least one hydraulic cylinder, wherein the pivoting movement is transferred to the lower linkages via lifting rods connected to the lifting arms.

When tilling heavy or wet soils, the tillage tools of soil-engaging accessory equipment usually have unwanted earth residues adhering to them after the accessory equipment has been lifted. These earth residues drop off at a later point in time, in particular when the agricultural tractor is on the move, and lead to dirty farm paths, agricultural paths and transport paths. This is especially critical when travelling on public roads.

The object of the present disclosure, therefore, is to specify a method of the type mentioned at the outset with regard to deliberately removing earth residues which adhere to the tillage tools of soil-engaging accessory equipment.

This object is achieved by a method for controlling a three-point hitch having the features of one or more of the following embodiments.

In the method for controlling a three-point hitch, the three-point hitch comprises left and right lower linkages, which are each pivotably linked to a tractor-side support structure in a first end region and have a coupling element for attaching accessory equipment in a second end region, wherein, by pivoting the lower linkages by means of a lifting mechanism, the coupling elements can be lifted and lowered with respect to the ground. According to the disclosure, in a cleaning mode, the lifting mechanism is activated at the instigation of a control unit in such a way that an acceleration pulse directed towards the ground is produced in the region of the coupling elements by interrupting a short-stroke lowering movement generated at the lower linkages.

The acceleration pulse produced as a result of the interruption, and therefore sudden deceleration, of the lowering movement results in a deliberate and effective flinging-off of earth residues which adhere to the soil-engaging tillage tools of the accessory equipment after this latter has been lifted out of the soil. The achievable cleaning effect naturally improves as the acceleration pulse and/or the amount of adhering earth residue increases.

The coordination of the “cleaning movement” generated in this way in the cleaning mode is realized automatically by the control unit and therefore in a particularly user-friendly manner, wherein the cleaning mode is activated, for example, before turning the agricultural tractor on a farm path or agricultural path adjoining the arable land to be tilled or before leaving the arable land in the direction of an access road.

The lifting mechanism provided for lifting and lowering the accessory equipment is generally hydraulically controllable and has left and right lifting arms, which can be pivoted about a common shaft by means of at least one common hydraulic cylinder. The pivoting movement here is transferred to the lower linkages via lifting rods connected to the lifting arms.

In established three-point hitches, the at least one hydraulic cylinder is usually of a single-acting design. In this case, to lift the lower linkages, a working chamber, designed as a piston chamber, of the at least one hydraulic cylinder can be acted upon by pressurized hydraulic fluid from a hydraulic system of the agricultural tractor via a lifting valve. The lowering movement is realized passively under the force of the gravity acting on the lower linkages or the accessory equipment located thereon, for which pressure is released from the piston chamber via a lowering valve to the effect that the hydraulic fluid may be discharged in the direction of a hydraulic reservoir under the influence of the gravity acting on the lower linkages or on the accessory equipment.

On the other hand, if a double-acting hydraulic cylinder with a further working chamber designed as an annular chamber is provided, the lower linkages are actively lowered, and thereby accelerated, by pressurizing the annular chamber of the at least one hydraulic cylinder whilst releasing pressure from the piston chamber.

In both cylinder designs, the interruption, and therefore blocking, of the lowering movement of the lower linkages is realized by closing the lowering valve with the minimum possible control delay. This leads to the production of a correspondingly steep (sudden) acceleration pulse.

In some embodiments, the lowering movement of the lower linkages which is executed in the cleaning mode is short-stroke insofar as it represents a mere fraction of the total available pivot angle of the lower linkages and amounts to a few angular degrees.

In some embodiments, the lowering movement of the lower linkages which is executed in the cleaning mode is short-stroke insofar as it represents a mere fraction of the total available pivot angle of the lower linkages and amounts to only a few angular degrees.

Advantageous developments of the method according to the disclosure can be found in one or more embodiments disclosed herein.

In some embodiments, to prevent the accessory equipment from colliding with the ground, which would lead to possible damage, the lowering movement is executed when starting from a lifted transport position of the lower linkages. In some embodiments, to prevent the accessory equipment from colliding with the ground, which would lead to possible damage, the lowering movement is executed only when starting from a lifted transport position of the lower linkages. The detection of the lifted transport position is realized by the control unit, for which the control unit analyzes the sensor data of an angle sensor, which serves to record the current lifting position of the lower linkages.

With regard to further improving the cleaning effect, it may be provided that the lowering movement is repeated in particular after firstly returning to the lifted transport position. Depending on the accessory equipment type and the respective soil conditions, the number of repetitions may be adapted by the driver, for example, via an operating terminal connected with the control unit. This may be realized either by specifying the desired number of repetitions directly via an input element or for as long as the operator continues to actuate (press) an associated operating element. Generally speaking, in the case of a plow used in heavy soil, the cleaning requirement may be greater than that for a harrow which only engages with the soil surface in dry soil conditions.

The cleaning mode may be activated manually via the operating terminal connected with the control unit or automatically. In the latter case, based on a comparison with the current position of the agricultural tractor as ascertained via the GPS navigation system, cartographic information relating to farm or agricultural paths adjoining the arable land to be tilled may be taken into account insofar as these paths are expected to be used when executing a turn between two adjacent rows of fields or when leaving the arable land after completing the soil tilling procedure and the execution of a cleaning procedure is therefore advisable. The execution of a turn may be communicated to the control unit, for example by a headland management system (not reproduced in the figures) of the agricultural tractor, as represented by the ITEC system of the manufacturer John Deere. The execution of the cleaning procedure here may be realized subject to firstly being enabled or confirmed by an operator via the operating terminal.

In addition, information relating to the soil properties or soil conditions, for example type and moisture of the soil to be tilled, can be included. The relevant information may be communicated either manually via the operating terminal or by receiving corresponding weather and soil information via a communications interface which is connected to the control unit and accesses an external server via a wireless network.

The execution of the cleaning procedure may be optionally expanded in the event that the three-point hitch has a central upper linkage pivotably linked to the tractor-side support structure, which upper linkage supports a further coupling element at its free end and may be altered in terms of its extension length by means of an actuator arrangement, wherein, in the cleaning mode, the actuator arrangement is activated at the instigation of the control unit in such a way that a shaking or vibrating movement is produced in the region of the further coupling element. The shaking or vibrating movement is distinguished by short-stroke deflections in the order of magnitude of several millimeters to approximately one centimeter, which follow one another in close or immediate succession.

To prevent excessive movements in the region of the accessory equipment, it may be provided that the shaking or vibrating movement is coordinated by the control unit in such a way that it is executed only when the lower linkages are stationary, in particular in their lifted transport position. Depending on the amount of dirt on the accessory equipment, it is also conceivable to limit the cleaning procedure entirely to executing the shaking or vibrating movement at the upper linkage. The corresponding selection may be made via the operating terminal.

The above and other features will become apparent from the following detailed description and accompanying drawings.

### BRIEF DESCRIPTION OF THE DRAWINGS

In the drawings:

FIG. 1A shows a rear view of an agricultural tractor with a three-point hitch, according to an embodiment; and

FIG. 1B shows a schematically illustrated block diagram of an example embodiment of the method for controlling a three-point hitch, according to an embodiment.

### DETAILED DESCRIPTION

The embodiments or implementations disclosed in the above drawings and the following detailed description are not intended to be exhaustive or to limit the present disclosure to these embodiments or implementations.

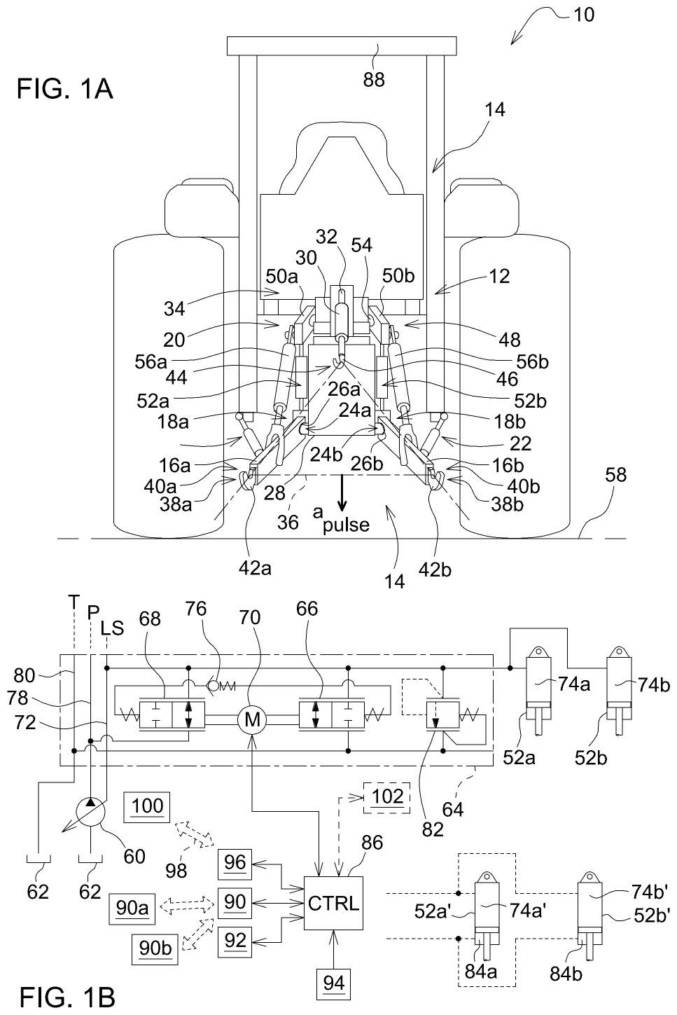

With reference to FIGS. 1A and 1B, the components used to execute the method according to the disclosure will firstly be discussed in more detail. These are part of an agricultural tractor 10 with a three-point hitch 14, which is arranged in its rear region 12 and serves for attaching, amongst other things, supported accessory equipment for soil tillage, for example a plough, a harrow, a cultivator or the like.

The three-point hitch 14 is of a conventional type and comprises left and right lower linkages 16a, 16b, which are each pivotably linked to a tractor-side support structure 20 in a first end region 18a, 18b. More precisely, left and right link points 24a, 24b are provided for this in a lower region 22 of the tractor-side support structure 20 and one of the two lower linkages 16a, 16b is fastened thereto in each case in its first end region 18a, 18b by means of a ball joint 26a, 26b. In the present case, the tractor-side support structure 20 is a differential housing 28.

A central upper linkage 30, which is pivotably arranged at a further link point 32 in an upper region 34 of the tractor-side support structure 20 or the differential housing 28, serves for the upper support or guidance of accessory equipment 36 (indicated by dashed lines in FIG. 1A) attached to the three-point hitch 14. The lower linkages 16a, 16b have respective coupling elements 42a, 42b at their free ends 38a, 38b in a second end region 40a, 40b opposite the first end region 18a, 18b. The upper linkage 30 also supports a corresponding further coupling element 46 at its free end 44. The coupling elements 42a, 42b, 46 have the form of self-locking arresting hooks in which the accessory equipment 36 is attached or suspended by means of ball couplers (not reproduced in FIG. 1A) of a complementary design.

To lift and lower the accessory equipment 36, a hydraulically controllable lifting mechanism 48 is provided, which has left and right lifting arms 50a, 50b which can be pivoted about a common shaft 54 by means of associated hydraulic cylinders 52a, 52b, wherein the pivoting movement is transferred to the lower linkages 16a, 16b via lifting rods 56a, 56b connected to the lifting arms. In this way, the coupling elements 42a, 42b provided on the lower linkages 16a, 16b, including the accessory equipment 36 suspended thereon, can be deliberately lifted and lowered with respect to the ground 58.

By way of example, the hydraulic cylinders 52a, 52b are of single-acting design. A hitch valve 64, which communicates with a load-controlled hydraulic pump 60 and a hydraulic reservoir 62 and has a lowering valve 66 and a lifting valve 68, serves to activate the hydraulic cylinders, wherein the two valves 66, 68 can be alternately opened and closed by means of an electric actuator 70 (for example a stepping motor) via an eccentric drive. Deviating from this, the valves 66, 68 comprised by the hitch valve 64 may also each be designed as an electrically controllable proportional valve. Like the hydraulic reservoir 62, the hydraulic pump 60, whereof the displacement volume can be set via a load indicator line 72, is also part of a superordinate hydraulic system of the agricultural tractor 10, which serves for the operation of a plurality of further hydraulic functions.

As can likewise be seen in FIGS. 1A and 1B, to lift the lower linkages 16a, 16b, working chambers—designed as piston chambers 74a, 74b—of the hydraulic cylinders 52a, 52b can be acted upon by pressurized hydraulic fluid via a non-return valve 76 by opening the lifting valve 68, which hydraulic fluid is supplied via a supply line 78 connected with the hydraulic pump 60. On the other hand, the lowering movement is realized passively under the force of the gravity acting on the lower linkages 16a, 16b or the accessory equipment 36, for which pressure is released from the piston chambers 74a, 74b by opening the lowering valve 66 to the effect that the hydraulic fluid may be discharged in the direction of the hydraulic reservoir 62 via a return line 80 under the influence of the gravity acting on the lower linkages 16a, 16b or on the accessory equipment 36.

To avoid transport-related pressure peaks in the piston chambers 74a, 74b of the hydraulic cylinders 52a, 52b, a pressure-limiting valve 82 is furthermore present, which creates a pressure-release connection in the direction of the hydraulic reservoir 62 in the event that a maximum permissible operating pressure in the range of 250 to 270 bar is exceeded.

On the other hand, if double-acting hydraulic cylinders 52a, 52b are used, these have further working chambers, designed as annular chambers 84a, 84b, wherein the hitch valve 64 is adapted in such a way that the lower linkages 16a, 16b are actively lowered by pressurizing the annular chambers 84a, 84b whilst releasing pressure from the piston chambers 74a, 74b (illustrated by dashed lines in FIG. 1B).

For completeness, it should be noted that the illustration of a three-point hitch 14 in the rear region 12 of the agricultural tractor 10 is merely exemplary. In addition or alternatively, a corresponding three-point hitch may also be present in the front region.

A control unit 86 (e.g., a controller including a processor and memory) serves to execute the method according to the disclosure, which control unit, in addition to the electric actuator 70 for controlling the lifting mechanism, is furthermore connected with an operating terminal 90 arranged in a driver's cab 88 of the agricultural tractor 10, a GPS navigation system 92 for ascertaining the current position of the agricultural tractor 10, an angle sensor 94 for detecting the current lifting position of the lower linkages 16a, 16b and a communications interface 96 for receiving, amongst other things, weather and soil information.

### Cleaning Mode

In a cleaning mode realized by the method according to the disclosure, the lifting mechanism 48 is activated via the hitch valve 64 at the instigation of the control unit 86 in such a way that an acceleration pulse aₚᵤₗₛₑ directed towards the ground 58 is produced in the region of the coupling elements 42a, 42b provided on the lower linkages 16a, 16b, including the accessory equipment 36 suspended thereon. This is realized by interrupting a short-stroke lowering movement in the order of magnitude of a few angular degrees, which is generated at the lower linkages 16a, 16b, by opening the lowering valve 66.

The acceleration pulse aₚᵤₗₛₑ produced as a result of the interruption, and therefore sudden deceleration, of the lowering movement leads to a deliberate and effective flinging-off of earth residues which adhere to the soil-engaging tillage tools of the accessory equipment 36 after this latter has been lifted out of the soil. The achievable cleaning effect naturally increases as the acceleration pulse aₚᵤₗₛₑ and/or the amount of adhering earth residue increases.

Irrespective of whether the cylinders are designed as single-acting or double-acting hydraulic cylinders 52a, 52b, the interruption, and therefore blocking, of the lowering movement of the lower linkages 16a, 16b is realized by closing the lowering valve 66 by means of the electric actuator 70 with the minimum possible control delay. This leads to the production of a correspondingly steep acceleration pulse aₚᵤₗₛₑ.

In some embodiments, to prevent the accessory equipment 36 from colliding with the ground 58, which would lead to possible damage, the lowering movement is executed only when starting from a lifted transport position of the lower linkages 16a, 16b. The detection of the lifted transport position here is realized by the control unit 86, for which the control unit analyzes the sensor data of the angle sensor 94, which serves to detect the current lifting position of the lower linkages 16a, 16b.

With regard to further improving the cleaning effect by generating a shaking movement, it is optionally provided that the lowering movement of the lower linkages 16a, 16b is repeated after firstly returning to the lifted transport position. Depending on the accessory equipment type and the respective soil conditions, the number of repetitions is adapted by the driver via the operating terminal 90 connected with the control unit 86.

This is realized at the operating terminal 90, either by specifying the desired number of repetitions directly via an input element 90a or for as long as the operator continues to actuate (press) an associated operating element 90b. Generally speaking, in the case of a plow used in heavy soil, the cleaning requirement may be greater than that for a harrow which only engages with the soil surface in dry soil conditions.

The cleaning mode is activated either manually via the operating terminal 90 or automatically. In the latter case, based on a comparison with the current position of the agricultural tractor 10 as ascertained via the GPS navigation system 92, cartographic information relating to farm or agricultural paths adjoining the arable land to be tilled is taken into account insofar as these paths are expected to be used when executing a turn between two adjacent rows of fields or when leaving the arable land after completing the soil tilling procedure and the execution of a cleaning procedure is therefore advisable. The execution of a turn may be communicated to the control unit 86, amongst other things by a headland management system (not reproduced in the figures) of the agricultural tractor 10, as represented by the ITEC system of the manufacturer John Deere. The execution of the cleaning procedure here is realized subject to firstly being enabled or confirmed by an operator via the operating terminal 90, for example by actuating the operating element 90b.

In addition, information relating to the soil properties or soil conditions, for example type and moisture of the soil to be tilled, are included. The relevant information is communicated either manually via the operating terminal 90 or by receiving corresponding weather and soil information via the communications interface 96, which is connected to the control unit 86 and accesses an external server 100 via a wireless network 98 for this purpose.

The extension length of the upper linkage 30 comprised by the three-point hitch 14 can optionally be altered by means of an actuator arrangement 102 designed as a hydraulic cylinder, wherein, in the cleaning mode, the actuator arrangement 102 is activated at the instigation of the control unit 86 in such a way that a shaking or vibrating movement is produced in the region of the further coupling element 46. The latter is distinguished by short-stroke deflections in the order of magnitude of several millimeters to approximately one centimeter, which follow one another in close or immediate succession.

In some embodiments, it is provided here that the shaking or vibrating movement is coordinated by the control unit 86 in such a way that it is executed only when the lower linkages 16a, 16b are stationary (i.e. the lifting mechanism 48 is not actuated), in particular in their lifted transport position. Optionally (depending on the amount of dirt on the accessory equipment 36), the cleaning procedure is limited entirely to executing the shaking or vibrating movement at the upper linkage. The corresponding selection may be made via the operating terminal 90.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for controlling a three-point hitch, having left and right lower linkages with each pivotably linked to a tractor-side support structure in a first end region and each having a coupling element for attaching accessory equipment in a second end region, comprising:
pivoting the lower linkages via a lifting mechanism which lifts and lowers the coupling elements with respect to the ground; and
activating the lifting mechanism in a cleaning mode via a control unit such that an acceleration pulse directed towards the ground is produced in the region of the coupling elements by interrupting a short-stroke lowering movement generated at the lower linkages.

2. The method of claim 1, wherein the short-stroke lowering movement is executed when starting from a lifted transport position of the lower linkages.

3. The method of claim 2, wherein the short-stroke lowering movement is repeated after first returning to the lifted transport position.

4. The method of claim 3, wherein the cleaning mode is activated automatically via the control unit.

5. The method of claim 3, wherein the cleaning mode is activated manually via the operating terminal connected with the control unit.

6. The method of claim 1, wherein the three-point hitch has a central upper linkage pivotably linked to the tractor-side support structure, which upper linkage supports a further coupling element at its free end and may be altered in terms of its extension length by means of an actuator arrangement, wherein, in the cleaning mode, the actuator arrangement is activated at the instigation of the control unit in such a way that a shaking or vibrating movement is produced in the region of the further coupling element.

7. The method of claim 6, wherein the shaking or vibrating movement is coordinated by the control unit such that it is executed when the lower linkages are in a lifted transport position.

8. A system for controlling a three-point hitch, comprising:
a left lower linkage and a right lower linkage, with each pivotably linked to a tractor-side support structure in a first end region and each having a coupling element for attaching accessory equipment in a second end region;
a lifting mechanism pivoting the left and right lower linkages such that the coupling elements can be lifted and lowered with respect to the ground; and
a control unit configured to activate the lifting mechanism in a cleaning mode such that an acceleration pulse directed towards the ground is produced in the region of the coupling elements by interrupting a short-stroke lowering movement generated at the lower linkages.

9. The system of claim 8, wherein the lowering movement is executed when starting from a lifted transport position of the lower linkages.

10. The system of claim 9, wherein the lowering movement is repeated after firstly returning to the lifted transport position.

11. The system of claim 10, wherein the cleaning mode is activated automatically via the control unit.

12. The system of claim 10, wherein the cleaning mode is activated manually via the operating terminal connected with the control unit.

13. The system of claim 8, further comprising:
a central upper linkage pivotably linked to the tractor-side support structure and supporting a further coupling element at a free end;
an actuator arrangement altering a length of the central upper linkage; and
the control unit configured to activate the actuator arrangement in the cleaning mode such that a shaking or vibrating movement is produced in the region of the further coupling element.

14. The system of claim 13, wherein the shaking or vibrating movement is coordinated by the control unit such that it is executed when the lower linkages are in a lifted transport position.
